(19) United States
(12) Patent Application Publication
(10) Pub. No.: US 2025/0217481 A1
(43) Pub. Date: Jul. 3, 2025

(54) INSIDER THREAT REPORTING MECHANISM

(71) Applicant: Fortinet, Inc., Sunnyvale, CA (US)

(72) Inventor: Sameer Khanna, Sunnyvale, CA (US)

(73) Assignee: Fortinet, Inc., Sunnyvale, CA (US)

(21) Appl. No.: 18/400,233

(22) Filed: Dec. 29, 2023

(51) Int. Cl. G06F 21/55

(52) U.S. Cl. CPC G06F 21/554; G06F 2221/034

(57) ABSTRACT

A system is disclosed. The system includes at least one physical memory device to store report generation logic and one or more processors coupled with the at least one physical memory device to execute the report generation logic to receive image data including a behavioral information, receive text data comprising a plurality of candidate reports, generate a plurality of image-report encodings based on the image data and the text data and generate a report based on the image-report encodings.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2023, Fortinet, Inc.

### FIELD

Embodiments discussed generally relate to systems and methods for generating reports of insider threats based on behavioral information encoded into an image format.

### BACKGROUND

Data security threats are often caused by outsiders attempting to access a computer network. However, threats from insiders are on the rise. Because the individual creating the threat enjoys a level of trust, such threats are often harder to detect that threats originating outside the boundary of trust. Further, successful completion of a threat by an insider can involve substantial costs.

Hence, there exists a need in the art for enhanced systems, methods, devices, and/or approaches for detecting and evaluating the threats.

### SUMMARY

Various embodiments provide systems and methods for detecting and reporting malicious behavior from within a secured network environment.

This summary provides only a general outline of some embodiments. Many other objects, features, advantages, and other embodiments will become more fully apparent from the following detailed description, the appended claims and the accompanying drawings and figures.

### BRIEF DESCRIPTION OF THE DRAWINGS

A better understanding of the embodiments can be obtained from the following detailed description in conjunction with the following drawings, in which:

FIGS. 1A-1C illustrate embodiments of a network architecture including a malicious behavior detection system;

FIG. 2 illustrates embodiments of images representing behavior;

FIG. 3 illustrates one embodiment of an insider threat reporting module;

FIG. 4 illustrates another embodiment of an insider threat reporting module;

FIG. 5 is a flow diagram illustrating one embodiment of a process for generating an insider threat report;

FIGS. 6A-6C illustrate embodiments of generated training data;

FIG. 7 illustrates one embodiment of a training module; and

FIG. 8 is a flow diagram illustrating one embodiment of a training process.

### DETAILED DESCRIPTION

Complex attack vectors are becoming more prevalent in which insiders pose threats to corporations and organizations of all scales due to their access to proprietary systems and their ability to circumvent security protocols and blind spots in which the public is not privy. For example, close to 30% of confirmed breaches today involve insiders. Each such attack costs an organization millions of dollars annually.

Unfortunately, these attacks are extremely difficult to detect from within. Current trends of advancement in the space of insider threat detection revolve around the usage of image encodings to represent employee behavior. Such image encodings may be implemented in insider threat detection models, which may be used to influence whether an employee suspected of malicious behavior is to be terminated or reprimanded due to the behavior. Thus, it is imperative that security experts performing an assessment understands the reason behind a model labeling an employee's behavior as malicious.

Additionally, there are concerns regarding data availability for insider threat detection. Traditional training data is composed of real-life scenarios, including confidential information for a company, as well as the personal information of their employees. Thus, each vendor utilizes their own private datasets, making model comparisons and benchmarking difficult in nature.

According to one embodiment, a report generation mechanism is provided to analyze image encoded behavioral information to detect potential malicious activity and generate a report indicating whether there has been malicious activity and a type of malicious activity upon a determination that the activity is malicious. In a further embodiment, training mechanisms are provided to generate training data implemented at the report generation mechanism.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting, or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS. SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

The phrase “text based information set” is used in its broadest sense to mean any information set that includes at least a portion of natural language text. As such, text based information sets may include, but are not limited to, text messages, emails, documents, or the like. Based upon the disclosure provided herein, one of ordinary skill in the art will recognize a variety of “text based information sets” to which systems and/or methods described herein may be applied.

The phrase “insider attack” is used in its broadest sense to mean any attack against or launched from a communication network where the perpetrator of the attack is a trusted insider. As one example, a trusted insider may be someone who has been granted permission to access the communication network and has accessed the communication network using such permission. This is in contrast to an outsider who has not been granted permission to access the communication network, but may have obtained access through illicit means. In some cases, an insider attack is made by a trusted insider who has accessed the communication network from within a trusted perimeter. Such a trusted perimeter may be, but is not limited to, within a building supported by the communication network using, for example, a computer assigned to the trusted insider that is connected to the communication network physically within the building.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

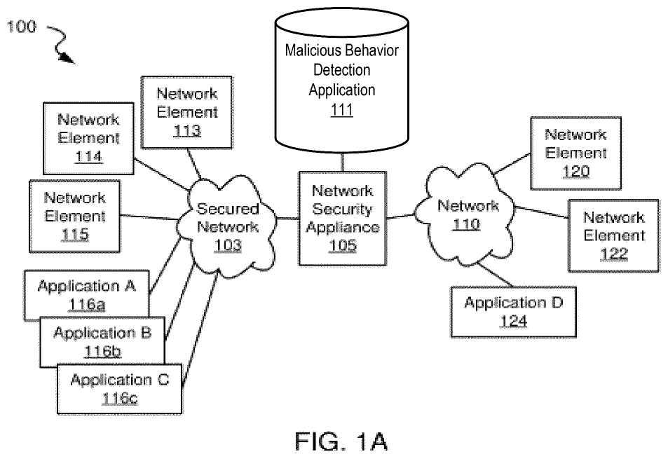

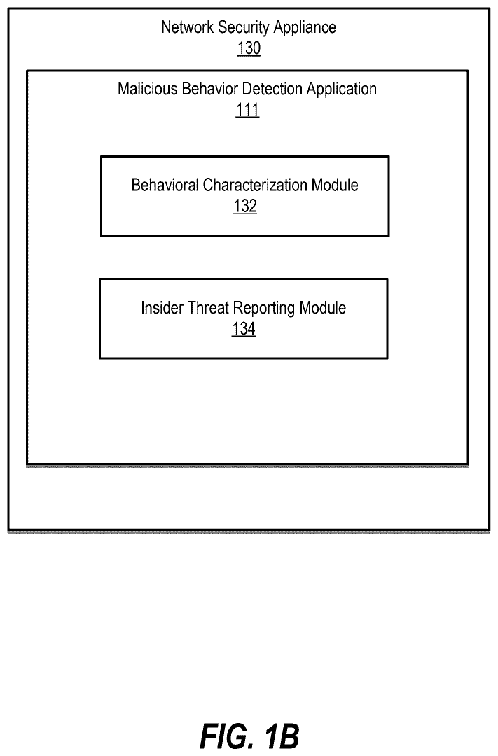

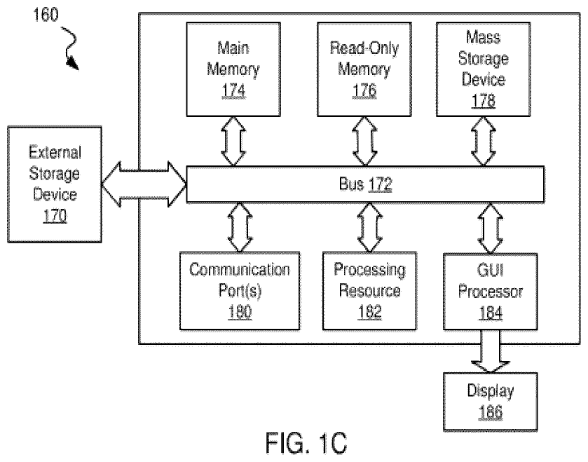

Turning to FIG. 1A, network architecture 100 is shown in accordance with some embodiments. In the context of network architecture 100, a network security appliance 105 controls access to network elements within a secured network 103. Secured network 103 may be any type of communication network known in the art. Those skilled in the art will appreciate that, secured network 103 can be a wireless network, a wired network, or a combination thereof that can be implemented as one of the various types of networks, such as an Intranet, a Local Area Network (LAN), a Wide Area Network (WAN), an Internet, and the like. Further, secured network 103 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

Secured network 103 provides for internetwork communications between network elements 113, 114, 115 and applications 116 (e.g., application A 116 a, application B 116 b, and application C 116 c). Network security appliance 105 operates as a gateway between secured network 103 and outside networks (e.g., a network 110). Network 110 may be any type of network known in the art. Thus, network 110 may be, but is not limited to, a wireless network, a wired network or a combination thereof that can be implemented as one of the various types of networks, such as the Internet, an Intranet, a Local Area Network (LAN), a Wide Area Network (WAN), and the like. Network security appliance 105 provides for communications between network element 113 and network element 120, network element 122, and network element 124 via network 110.

Network security appliance 105 executes a malicious behavior detection application 111 that is maintained on a computer readable medium communicably coupled to network security appliance 105. Execution of malicious behavior detection application 111 by network security appliance 105 causes the generation of behavioral information encoded in image and an analysis of the encoded image with corresponding text based potential threat reports to generate a malicious activity report which indicates whether malicious activity has been detected.

Turning to FIG. 1B, an embodiment of a network security appliance 130 including a malicious behavior detection application 111 is illustrated. As shown, malicious behavior detection application 111 includes a behavioral characterization module 132 and an insider threat reporting module 134. Behavioral characterization module 132 encodes behavioral information into an image format to facilitate image-based behavioral information. Insider threat reporting module 134 generates an insider threat report based on the encoded image generated at malicious behavior detection application 111.

Turning to FIG. 1C, an example computer system 160 is shown in which or with which embodiments of the present disclosure may be utilized. As shown in FIG. 1C, computer system 160 includes an external storage device 170, a bus 172, a main memory 174, a read-only memory 176, a mass storage device 178, one or more communication ports 180, one or more processing resources (e.g., processing circuitry 182), and a graphical user interface (GUI) processor 184. GUI processor 184 drives a display 186. In one embodiment, computer system 160 may represent some portion of any of network security appliance 105.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g., start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such as front side bus (FSB), which connects processing resources to software systems.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 190 can be any kind of external hard-drives, floppy drives, IOMEGA® Zip Drives, Compact Disc-Read Only Memory (CD-ROM), Compact Disc-Rewritable (CD-RW), Digital Video Disk-· Read Only Memory (DVD-ROM). Components described above are meant only to show various possibilities. In no way should the aforementioned example computer systems limit the scope of the present disclosure.

As discussed above with reference to FIG. 1B, behavioral characterization module 132 generates images encoded with behavioral information. According to one embodiment, generating a behavioral encoded image comprises accessing a number of behavioral features. Such behavioral features may be any group of activities or attributes associated with a group being monitored, and may be derived from accessing one or more data sources. For example, the data sources from which behavioral features are accessed included user login information, lightweight directory access protocol (LDAP) information, website access information, file access information, external device information, and email activity information.

Additionally, behavioral characterization module 132 yields behavioral features based on the accessed behavioral features, form the behavioral features into a feature array where each location in the feature array includes behavioral features of a feature type defined for that location, encode the feature array into a grayscale image and incorporate multiple grayscale images to yield a color image. The processes performed by behavioral characterization module 132 to generate images encoded with behavioral information is further discusses in U.S. patent application Ser. No. 17/831,172 entitled “SYSTEMS AND METHODS FOR ENCODING BEHAVIORAL INFORMATION INTO AN IMAGE DOMAIN FOR PROCESSING”, and filed Jun. 2, 2022 by Khanna.

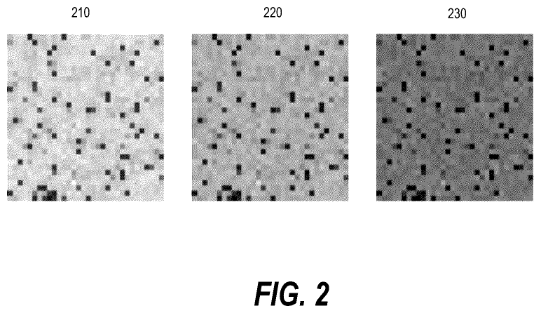

FIG. 2 illustrates embodiments of grayscale images created using the processes employed by behavioral characterization module 132. As shown in the example images, different locations within a pixel array may have a different grayscale value (e.g., from 0-255) that corresponds to a behavioral feature underlying the particular location within the image. In one embodiment, each of the respective images represents a different target and/or period of a feature window. As one example, grayscale image 210 may represent the current day for a particular target, grayscale image 220 may represent the preceding day for the particular target, and grayscale image 230 may represent two days earlier for the particular target. As another example, grayscale image 210 may represent the current day for a particular target, grayscale image 220 may represent the current day for a first target, and grayscale image 230 may represent the current day for a third target.

According to one embodiment, the grayscale images and potential insider threat reports are used to generate insider threat reports. In such an embodiment, the types of behavior included in one or more potential insider threat reports may indicating types of malicious behavior. For example, a potential insider threat report may include text data that a user logged in, connected to a drive, and uploaded to a corporate espionage site.

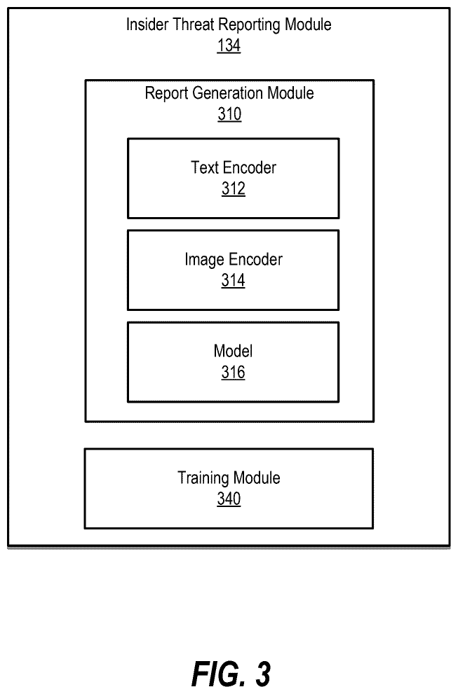

FIG. 3 illustrates one embodiment of an insider threat report module 134 including a report generation module 310. Report generation module 310 includes text encoder 312 and image encoder 314. In one embodiment, the provided behavior image as well as a plurality of candidate reports (e.g., potential insider threat reports) are encoded by image encoder 314 and the text encoder 312, respectively, to generate an image-report encoding that includes image encoding I and the report encodings. Report generation model 316 analyzes the encodings to generate an insider threat report.

In one embodiment, report generation model 316 comprises a transferable visual model learned from natural language supervision that selects a report from a plurality of stored reports. In this embodiment, the selected (or retrieved) report comprises a report associated with a stored image-text pair (x_{image}, xₜₑₓₜ) that matches one of the image-report encodings. In a further embodiment, the matching stored image-text pair comprises an image-text pair having a highest cosine similarity with an image-report encoding, such that:

$$Index of Retrieved Report = {arg max}_{i} \frac{I \cdot {T}_{i}}{\vert I \vert \vert {T}_{i} \vert}$$

In one embodiment, this is done by having an image encoder create an image encoding, or vector-based representation of the image, and the corresponding text encoder do the same thing with all possible reports/pieces of text. As both the image encoder and text encoder are trained so that matching images and text will have their corresponding encodings pointing in the same direction, their cosine similarity will be high. The given image encoding is compared to the encodings for all possible pieces of text. The report encoding most similar in direction/angle will have the highest cosine similarity, and will thus be the report returned.

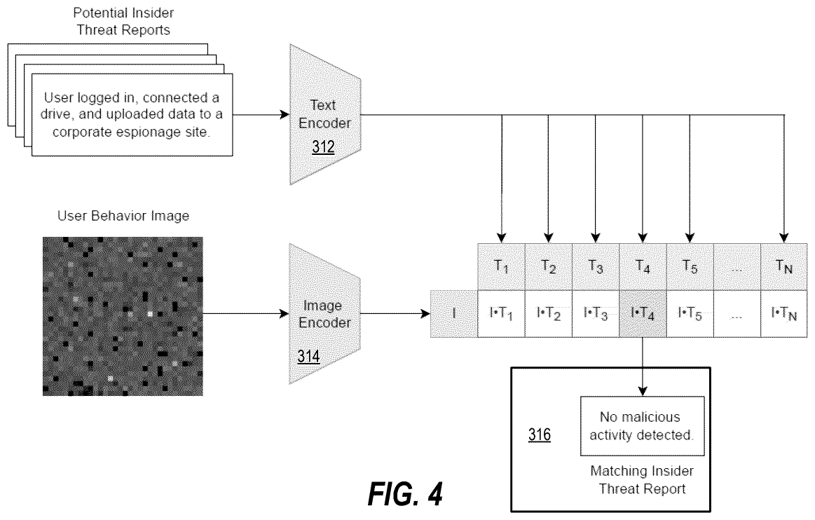

FIG. 4 illustrates another embodiment of a report generation module. As shown in FIG. 4, the provided behavior image as well as the potential reports are encoded by image encoder 314 and the text encoder 312, respectively, leading to the image encoding I and the report encodings T₁, T₂, . . . , T_{N}. Model 316 then selects a matching report (e.g., corresponding to the I*T₄ encoding. Subsequently, the report is transmitted to a system administrator (e.g., via a user interface). In one embodiment, the selected report indicates whether malicious activity has been detected from the behavioral information in the encoded image, and the type of activity upon a determination that malicious activity has occurred. In such an embodiment, the type of malicious activity is included with text information stored with selected image-text pair.

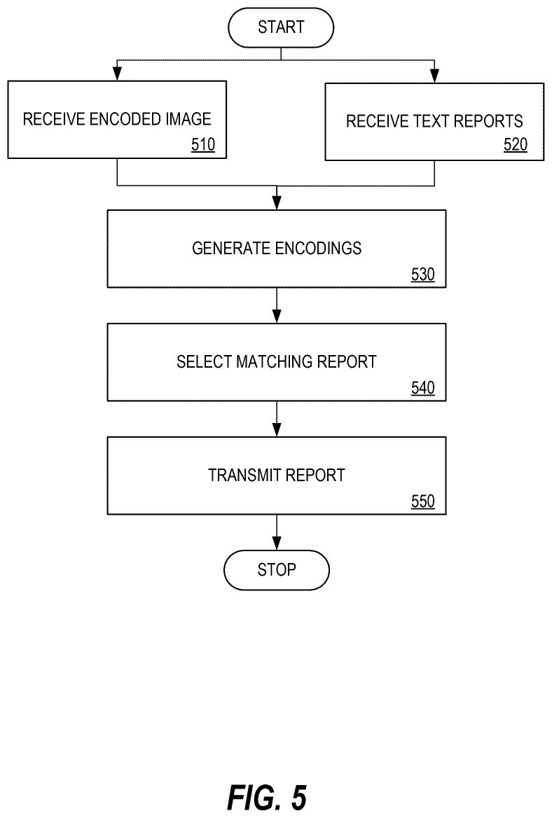

FIG. 5 is a flow diagram illustrating one embodiment of a process for generating an insider threat report. At processing block 510, behavioral information encoded in an image is received. At processing block 520, the text reports are received. At processing block 530, the image-text encodings are generated. At processing block 540, a matching report is selected, as described above. At processing block 550, the report is transmitted. In one embodiment, the report may be displayed at a display device (e.g., display 186) or printed to a medium.

Insider threat report module 134 also includes a training module 340 that is implemented to train report generation module 310. According to one embodiment, the grayscale images may be used to train a model used to generate insider threat reports. As a result, insider threat report module 134 may receive grayscale images to enable training module 340 to train report generation module 310 to generate insider threat reports.

Referring back to FIG. 3, training module 340 uses contrastive language image pre-training (CLIP) to train report generation module 310 such that true image-text pairs have a high cosine similarity, while false image-text pairs have a low cosine similarity. At training time, training module 340 samples a batch of N input pairs (x_{image}, xₜₑₓₜ) are sampled, where x_{image} refers to the image and xₜₑₓₜ refers to the corresponding text in a sample report. Using image encoder 314 and text encoder 312, the subsequent encodings (I, T) are generated. The pair i of input pair encodings are denoted as (Iᵢ, Tᵢ). In one embodiment, the training objective comprises the following loss functions:

$${( {loss}_{image - text} )}_{i} = - log ( \frac{exp ( \frac{I \text{?} \cdot T \text{?}}{\vert I \text{?} \vert \vert T \text{?} \vert}}{{\sum }_{k = 1}^{N} exp ( \frac{{I}_{i} \cdot {T}_{k}}{\vert {I}_{i} \vert \vert {T}_{k} \vert} )} )$$

$${( {loss}_{text - image} )}_{i} = - log ( \frac{exp ( \frac{I \text{?} \cdot T \text{?}}{\vert I \text{?} \vert \vert T \text{?} \vert}}{{\sum }_{k = 1}^{N} exp ( \frac{{I}_{k} \cdot {T}_{i}}{\vert {I}_{k} \vert \vert {T}_{i} \vert} )} )$$

$$\text{?} \text{indicates text missing or illegible when filed}$$

In a further embodiment, the above loss functions are combined via an average, resulting in the following contrastive loss for the training batch:

$$ℒ = \frac{1}{2 N} {\sum }_{i = 1}^{N} {( {loss}_{image - text} )}_{i} + {( {loss}_{text - image} )}_{i}$$

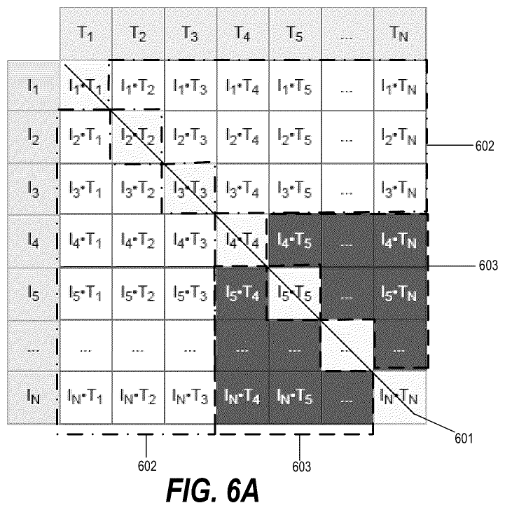

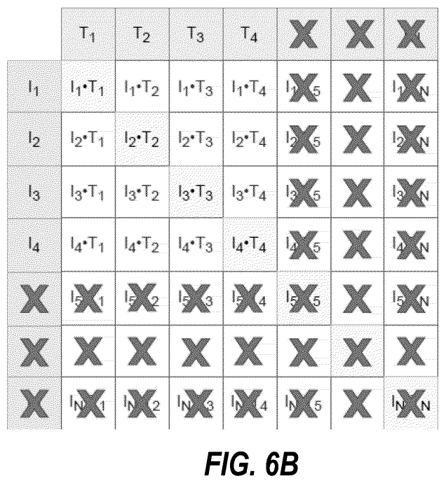

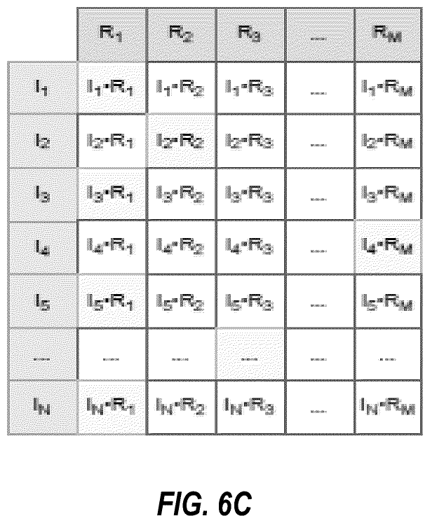

A problem with the above contrastive learning approach is that the insider threat problem space is highly imbalanced. Additionally, a generated report needs to explain why a particular behavior image corresponds to malicious behavior. Moreover, the report need not provide additional information upon a determination that the behavior image corresponds to benign behavior. As a result, the majority class for the problem space has far lower diversity of possible reports than the minority class. FIG. 6A illustrates one embodiment of batch data generated from standard contrastive learning training. As shown in FIG. 6A, there are numerous false negative image-text pairs within a batch. For example, squares 601 indicate true positive image-text pairs, squares 602 indicate true negative image-text pairs and squares 603 indicate false positive pairs. As shown, multiple correct reports are in the same training batch (T4=T5= . . . =TN). As a result, contrastive learning will treat all image-text pairs (Iⱼ, Tₖ) where j/=k, j∈[4, 5, . . . , N], k∈[4, 5, . . . ,N] as negative image-text pairs despite in actuality being positive image text pairs. A positive pair of image-text occurs when both the image and text correspond to similar behavior. For example, a positive pair could be an image of benign behavior and a report that says “No malicious behavior detected.” Another example could be an image of malicious behavior such as repeated information stealing via thumb drive, and the corresponding report of the pair would be a report that indicates this behavior. A negative pair of image-text occurs when the image and text do not hold the same information. An example could be an image of benign behavior and a report saying “Repeated use of thumb drive in various computers detected. Further investigation is warranted.” Based on the training data contrastive learning will attempt to increase the distance between images and reports that should be brought close together. As a result, retrieval performance of the trained image and text encoders is negatively hampered when certain pairs are taught to the image and text encoders as false negatives.

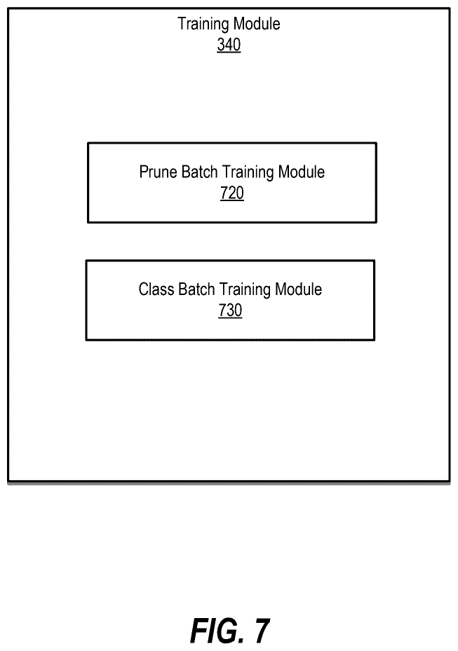

According to one embodiment, training module 340 implements novel contrastive learning mechanisms to improve training performance. FIG. 7 illustrates one embodiment of training module 340 including a prune batch training module 720 and a class batch training module 730. Prune batch training module 720 removes image-text pairs in instances in which there is an identical report already in the batch in order to reduce the false negative image-text pairs within a batch. Removing identical reports results in improved model training and enhanced text retrieval in the report generation model. FIG. 6B illustrates one embodiment of prune batch data in which identical reports have been removed.

While PruneBatch does not have the same issues with false negative pairs as conventional contrastive learning batching, each training batch removes significant amounts of useful training data. Accordingly, the subsequent model will be less reliable and will more easily overfit the data since reducing the amount of training data leads to a reduction in diversity in training examples. More importantly, increasing batch sizes is important for improving contrastive learning models as larger batch sizes increase the ratio of negative pairs to positive pairs. For example, there will be B2-B negative pairs and B positive pairs for a given batch size B. As B increases, the number of negative pairs increases faster than the number of positive pairs. Higher negative pair to positive pair ratios empirically lead to higher quality models. However, the PruneBatch process is effectively doing the reverse (e.g., decreasing the ratio of images and texts that would lead to this issue.

According to one embodiment, class batch training module 730 may be implemented to enable a text report to be used for a correct image-text pair multiple times within a batch. Thus, the text related to a particular image is treated as a class rather than image-text within a batch as pairs, where a class number corresponds to the index of the given report within the set of all possible reports. FIG. 6C illustrates one embodiment of class batch data. The class batch training approach provides two major benefits over PruneBatch. First, training data is no longer being removed at training time, reducing the likelihood of overfitting. Second, the correct text report is being contrasted for a particular behavior image to all possible text reports, which significantly improves alignment between an image and its corresponding text report (e.g., by maximizing the ratio of negative pairs to positive pairs irrespective of the training batch size).

Due to the highly imbalanced nature of the problem space, some reports will appear as the correct report significantly more often than others. Thus, in embodiments, modified contrastive loss is implemented to take into account class weights to train a ClassBatch in order to combat potential issues that may occur because of the imbalanced nature. The modified contrastive loss may be represented as follows:

$${ℒ}_{ClassBatch} = - \frac{1}{N} {\sum }_{i = 1}^{N} {W}_{{T}_{i}} log ( \frac{exp ( \frac{I \text{?} \cdot {R}_{R == {T}_{i}}}{\vert I \text{?} \vert \vert {R}_{R == {T}_{i}} \vert} )}{{\sum }_{r = 1}^{R} exp ( \frac{{I}_{i} \cdot {R}_{r}}{\vert I \text{?} \vert \vert R \text{?} \vert} )} )$$

$$\text{?} \text{indicates text missing or illegible when filed}$$

W_{Ti} denotes the weight corresponding to the text Tᵢ, where each W_{Ti} is determined such that every report type has equal weighting during training. R_{R==Ti} corresponds to the report in the set of all possible reports that matches input text Tᵢ. In one embodiment, there is now an unequal number of images and texts being compared, with each image having one possible associated report. However, not every report has a single associated behavior image. As a result, the ClassBatch loss function solely comprises an image-to-text contrastive loss as applied between the images in the batch and all possible reports.

According to one embodiment, image captioning may be divided into two components. In such an embodiment, image encoder 344 comprises a computer vision encoder that extracts features and nuances out of input images and a language based decoder that translates features and objects provided by the image based model to a natural language sentence.

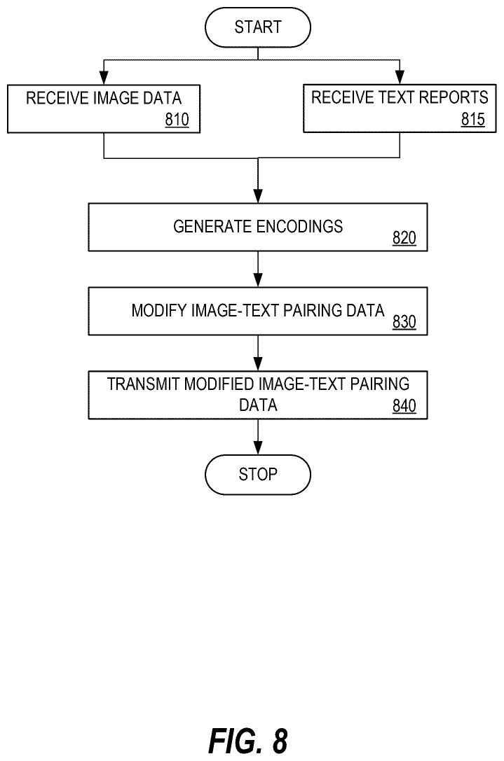

FIG. 8 is a flow diagram illustrating one embodiment of a training process. At processing blocks 810 and 815, image data (e.g., included in behavior encoded image blocks) and text reports, respectively, are received. At processing block 820, encoding data (e.g., image-text pairing data) is generated based on the received images and text reports. As discussed above, the image-text pairing data is generated using contrastive language image pre-training (CLIP). At processing block 830, the image image-text pairing data is modified to generate modified contrastive learning data. As discussed above, the image-text pairing data may be modified by removing image-text pairs in instances for identical reports in a batch of image-text pairs in order to reduce the false negative image-text pairs. Alternatively, the image-text pairing data may be modified by performing classifying text related to each of a plurality of images. At processing block 840, the modified contrastive learning data is transmitted to report generation module 310.

Thus, it will be appreciated by those of ordinary skill in the art that the diagrams, schematics, illustrations, and the like represent conceptual views or processes illustrating systems and methods. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing described embodiments. Those of ordinary skill in the art further understand that the exemplary hardware, software, processes, methods, and/or operating systems described herein are for illustrative purposes and, thus, are not intended to be limited to any particular named.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments, other and further embodiments may be devised without departing from the basic scope thereof. The scope of the embodiments is determined by the claims that follow. The embodiments are not limited to the described embodiments, versions or examples, which are included to enable a person having ordinary skill in the art to make and use the embodiments when combined with information and knowledge available to the person having ordinary skill in the art.

What is claimed is:

1. A system comprising:
at least one physical memory device to store report generation logic; and
one or more processors coupled with the at least one physical memory device to execute the report generation logic to:
receive image data including behavioral information;
receive text data comprising a plurality of candidate reports;
generate a plurality of image-report encodings based on the image data and the text data; and
generate a report based on the image-report encodings.

2. The system of claim 1, wherein the report generation logic generating the report comprises selecting a first of a plurality of reports associated with an image-text pair that matches an image-report encoding.

3. The system of claim 2, wherein the report matching the image-text pair comprises an image-text pair having a highest cosine similarity with the image-report encoding.

4. The system of claim 2, wherein the selected report indicates whether malicious activity has been detected from the behavioral information in the encoded image.

5. The system of claim 4, wherein the selected report indicates whether the malicious activity has been detected in the image data.

6. The system of claim 5, wherein the selected report indicates a type of malicious activity upon a determination that the malicious activity has occurred.

7. The system of claim 2, wherein the report generation logic comprises a transferable visual model to generate the report.

8. The system of claim 7, wherein the report generation logic further to train the transferable visual model.

9. The system of claim 8, wherein training the transferable visual model comprises:
generating a batch of image-text pairs based on a plurality of images and a plurality of text reports; and
modifying the batch of image-text pairs.

10. The system of claim 9, wherein modifying the batch of image-text pairs comprises removing image-text pairs in instances in which there is an identical report already in the batch in order to reduce false negative image-text pairs within a batch.

11. The system of claim 9, wherein modifying the batch of image-text pairs comprises classifying text related to each of the plurality of images.

12. The system of claim 11, wherein a classification comprises a class number that corresponds to an index of a text report within the plurality of reports.

13. The system of claim 11, wherein classifying the text comprises performing a contrastive loss operation.

14. A method comprising:
receiving image data including behavioral information;
receiving text data comprising a plurality of candidate reports;
generate a plurality of image-report encodings based on the image data and the text data; and
generate a report based on the image-report encodings.

15. The method of claim 14, further comprises training a transferrable visual model to generate the report.

16. The method of claim 15, wherein training the transferable visual model comprises:
generating a batch of image-text pairs based on a plurality of images and a plurality of text reports; and
modifying the batch of image-text pairs.

17. The method of claim 16, wherein modifying the batch of image-text pairs comprises removing image-text pairs in instances in which there is an identical report already in the batch in order to reduce false negative image-text pairs within a batch.

18. The method of claim 16, wherein modifying the batch of image-text pairs comprises classifying text related to each of the plurality of images.

19. At least one non-transitory computer readable medium having instructions stored thereon, which when executed by one or more processors, cause the processors to:
receive image data including behavioral information;
receive text data comprising a plurality of candidate reports;
generate a plurality of image-report encodings based on the image data and the text data; and
generate a report based on the image-report encodings.

20. The computer readable medium of claim 19, having instructions stored thereon, which when executed by one or more processors, further cause the processors to train a transferrable visual model to generate the report.
